(19) United States
(12) Patent Application Publication
(10) Pub. No.: US 2011/0182420 A1
(43) Pub. Date: Jul. 28, 2011

(54) ACCESS MANAGEMENT FOR CONNECTION-ACCOMPANYING DATA OF TELECOMMUNICATION CONNECTIONS

(75) Inventor: Gerhard Kramarz von Kohout, Bonn (DE)

(73) Assignee: DEUTSCHE TELEKOM, Bonn (DE)

(21) Appl. No.: 13/055,190

(22) PCT Filed: Jul. 17, 2009
(86) PCT No.: PCT/EP09/05206

§ 371 Date: Mar. 30, 2011

(30) Foreign Application Priority Data
Jul. 31, 2008 (DE) 10 2008 035 763.4

(51) Int. Cl. H04L 9/28

(52) U.S. Cl. 380/28

(57) ABSTRACT

The invention relates to a method and a device for carrying out the method for the ability to regulate and control the storage and access of connection-accompanying data of a telecommunications connection.

The invention is characterized in that a storage of the data takes place according to to specifications of the respective telecommunications subscriber and/or the respective network operator involved and the recorded data of the telecommunications connection are stored directly in the network of the used telecommunications network and, in this connection are protected from general access. In general, access is only possible after appropriate release by those involved in the telecommunications connection. Third Parties can only have access in the case of appropriate authorization.

The invention relates to a method for access management for connection-accompanying data of telecommunication connections in accordance with the preamble of claim 1.

A method for the reproducibility (recording) of a telephone conversation generally known from the prior art is disclosed with Publication DE 10 2004 026 021 A1, wherein for the reproducibility of a telephone conversation the voice signals produced in the telephone conversation are tapped near the end-device and stored in a receiving unit, which for example is connected by means of Bluetooth to the end-device and the recorded telephone conversation can be tapped by means of the input of a release code, such as for example a PIN code (Personal Identity Number).

The essential disadvantage in this connection is that the voice signals can basically only be reproduced and retrieved by one of the two subscribers, whereas the other subscriber in general has no control over the recording and no direct access to the storage medium or system of his conversation partner.

In addition the recorded voice signals are likewise not directly accessible to a third person.

Conversations in a German telecommunications network between at least two telephone subscribers are subject to German telecommunications secrecy, which currently does not allow a recording of telephone conversations unless all persons participating in the conversation consent to this recording prior to the conversation.

It is known that conversations even on the telephone are basically “transient”.

This means that after the completion of a conversation the spoken words of the subscribers are lost or are not reproducible and in the best case are only present in the memory of the participants.

However, there are a plethora of reasons for the participating subscribers of a telephone conversation to prepare the spoken words in reproducible manner, because it seems interesting and important to them to be able to listen to a conversation at a later time once again verbatim. This is the case for example when important circumstances of an upcoming conclusion of a contract are discussed between two subscribers, which should be reproducible for written implementation of the contract.

Under certain requirements it can likewise also be important or necessary for third parties to have access to the contents of a telephone conversation that has already been conducted, in which they themselves did not participate.

This applies not only for telephone conversations but rather also accordingly for other kinds of electronic communication, such as for example circuit switched or packet switched data traffic between two subscribers as well as also “IP sessions” of a subscriber.

End-device-based solutions currently exhibit the previously described limitations.

From the current perspective up to now no adequate or net-based solution belonging to the state of the art has been disclosed.

Similar to the mentioned publication DE 10 2004 026 021 A1, end-devices or add-on devices for end-devices are available on the market which make possible the recording of a conversation conducted via said end-device. The use of such end devices or add-on devices is, however at least from a legal point of view problematic, since the conversation partner as a rule does not have knowledge of the technical possibilities of the opposite side or the conversation is sometimes being recorded by the opposite side without his prior consent.

Hence the conversation partner of persons having such an end device or add-on device at their disposal does not have any control options as to whether the conducted conversation is recorded or not.

In addition it is not technically possible for Third Parties in this way purposefully to realize recordings without the knowledge or consent of the participants, even if said Third Parties were authorized to do so.

In addition it is known that the monitoring of telephone conversations, in which the telecommunication of a single subscriber—as a rule by court order—is to be monitored (“Legal interception”), is not technically realized via a net-based recording.

Instead of this, in switching technology corresponding devices, for example conference bridges are used, with which telecommunications connections are so to speak “doubled” and the copy is diverted to the connection of a Third Party, as a rule an agency authorized for this purpose.

Only at the connection of this Third Party is the telecommunications connection recorded and evaluated.

The monitored subscribers themselves however have no access to the recorded telecommunication.

Hence a private usage of such monitoring technology is currently generally out of the question.

Hence currently there are no net-based solutions for the recording of a telephone conversation known, which under controlled conditions facilitate a later usage of the recordings in particular by subscribers of the conversation and/or by Third Parties authorized to do so.

For this reason the present invention sets itself the task of specifying a method and a device for the carrying out the method for access management connection-accompanying data of a telecommunications connection, wherein the recorded connection-accompanying data are stored network internally from general access and the data can be reproduced in the simplest manner, in order to make access possible exclusively to authorized persons.

For the solution of the set task the invention is characterized by the features of claim 1.

In accordance with the invention the method is concerned with the ability to regulate and control the storage of the connection-accompanying data (e.g. call number of the calling A subscriber, call number of the called B subscriber, time etc.) of telephone conversations and other forms of telecommunication such as for example circuit switched or packet switched data connections with one or more subscribers and subsequent access to the stored data.

In addition to storage and administration of the connection-accompanying data of a telecommunications connection in accordance with the invention provision can be made to record the contents of the corresponding telecommunications connection and securely administer said contents.

One significant advantage of the invention is the fact that the conversation or telecommunications connection signals to be recorded can be stored directly as encrypted files on the network of the telecommunications network used, wherein said data files can be decrypted, and their contents reproduced, only after appropriate release by the subscribers of the telecommunications connection.

Another significant advantage is the fact that in dependency on the embodiment the data files of the recorded telecommunications connections can be reproduced by Third Parties if they have an appropriate authorization for decryption of the data files.

Hence the objective lies in solving the previously described problem comprehensively by means of the subject matter of the invention described here.

Customers and or subscribers of a telecommunications provider—regardless of whether it is a matter of communications via mobile telephony, fixed network or the Internet —have in the realization of the inventive concept the advantage of having access in the simplest manner to the contents and the connection data of the telecommunications connection already conducted if this is desired or required.

As a result of this for example a user knows already prior to the beginning of a telephone conversation that important information from the following telephone conversation cannot be lost and can be listened to later once more.

Depending on the embodiment of the invention the solution disclosed here also offers authorized Third Parties access to copies of the contents of the telephone conversation or of the connection-accompanying data.

In addition, depending on the embodiment the inventive concept realizes the ability to regulate and control a recording of a telecommunications connection, which takes place in particular subject to the relevant legal provisions of data protection and telecommunications secrecy.

In the case of a telecommunications connection between the two subscribers A and B in one of the participating switching systems the signals associated with the telecommunications connection, in particular the connection data and if applicable the contents, are duplicated for example via a conference bridge.

This can be implemented both in the switching system of the connecting network as well as also that of the network providing the connection.

The duplicate, that is the copy for example of the connection data and if applicable the content data of a telephone conversation, is preferably forwarded to a system suitable for this purpose.

The contents of the duplicate are recorded there and after digitizing, if required, and recoding to a suitable format, such as for example for a telephone conversation to “mp3 format”, are stored as a “recording” of the connection.

Depending on the embodiment of the invention the storage of the duplicate digitized or recoded as needed takes place in a cryptographically secured manner.

In the case of data connections between two subscribers or in the case of accesses of individual subscribers to computer-supported systems, such as for example by “surfing on the Internet”, the same applies. Here too in one of the participating switching systems or servers a copy can be created, which in the original format or after recoding to a suitable format preferably can be backed up cryptographically and be stored as a “recording” of the telecommunications connection.

The central aspect of the present invention is making available on the one hand the configurability of the control of which connection-accompanying data for which connections are to be stored and on the other hand the development of a freely selectable determination of who has access in which way to the stored connection-accompanying data.

### Control

Different embodiments for control of which connection-accompanying data are to be stored are possible, which can be realized in parallel or individually:

The subscriber wishes to store the connection-accompanying data associated with his volume of communication including the complete destination numbers.

For this purpose the subscriber must give his network operator corresponding instructions beforehand.

The subscriber wishes to store the connection-accompanying data associated with his volume of communication, wherein the destination numbers are anonymized or shortened.

For this purpose the subscriber must give his network operator corresponding instructions beforehand.

The subscriber wishes to store the connection-accompanying data associated with his volume of communication, wherein the destination numbers are not included.

For this purpose the subscriber must give his network operator corresponding instructions beforehand.

The subscriber does not wish to store the connection-accompanying data associated with his volume of communication.

For this purpose the subscriber must give his network operator corresponding instructions beforehand.

Connection-accompanying data which contain subscriber-related data from more than one subscriber (for example complete call number of the caller and the person being called) will only be saved if all participating communications partners have given their consent beforehand.

If the subscribers belong to different network operators this information about consent must have been exchanged between the network operators beforehand.

The declaration of the communications partners can take place generally beforehand or at the beginning of a telecommunications connection. In the second case consent preferably relates only to the one subsequent telecommunications connection and hence has no effects on subsequent telecommunications connections. Such consent is made possible for example by a generated announcement of the type:

>>The connection data of this conversation will, if you wish, be recorded. Please consent to the recording by pressing the “*” button now.<<

Only if both subscribers consent, to remain in the example, by pressing the “*” key, does a recording of the data take place.

The recording of the conversation and if applicable contents takes place then depending on the embodiment immediately or not until further information of the subscribers, for example by the announcement of the recorded message:

>>The connection data of this conversation, as you wished, will be recorded.<<

As an alternative the information for the consent of subscribers to this method is centrally stored in a database for example by a national regulatory body. For example, this database can be queried during the establishment of a telecommunications connection and the authorization for storage of the connection data can be obtained.

Which approach may be practiced by network operators or appropriate service providers with regard to the connection-accompanying data is in particular dependent on the respective legal situation with regard to data protection and telecommunications secrecy which apply for the providers of the aforementioned services or for the network operators.

Thus for one thing different embodiments for control of which telecommunications connections are to be included in the recording are possible, said embodiments being able to be realized in parallel or individually. As an example a telecommunications connection between a subscriber A and a subscriber B is assumed:

Subscribers A and B must both have signed on for the service of recording a telecommunications connection beforehand with reference to the call numbers or other identifications used by them.

This means that all telecommunications connections between the two subscribers who have consented to such a service will be recorded.

If subscribers A and B belong to different network operators, this information about consent must have been exchanged between the network operators beforehand.

As an alternative the information for the consent of subscribers to this method is centrally stored in a database for example by a national regulatory body. During the establishment of a connection this database can be queried and the authorization for recording of the connection can be obtained.

Both subscribers A and B consent to the recording before the beginning of their conversation.

This is for example possible by means of a generated network announcement of the type:

>>This conversation will, if you wish, be recorded. Please consent to the recording by pressing the “*” button now.<<
Only if both subscribers consent, to remain in the example, by pressing the “*” key, does a recording of the conversation take place.

The recording of the conversation takes place then depending on the embodiment immediately or not until further information of the subscribers, for example by the announcement of the recorded message:

>>This conversation, as you wished, will be recorded from this point on.<<

This form of consent relates only to the one following conversation and hence has no effects on subsequent conversations.

In principle all telecommunications connections will be recorded by the network operator.

Conversations will be recorded by the network operator in accordance with the guidelines of Third Parties, for example government agencies, who arrange the recording of all telecommunications connections by subscribers to be determined for a specific period of time.

Which approach may be practiced by network operators or appropriate service providers with regard to the recording of telecommunications connections is in particular dependent on the respective legal situation with regard to data protection and telecommunications secrecy which apply for the providers of the aforementioned services or for the network operators.

The current requirements of the European guideline on “Data Retention” as well as the corresponding national laws which implement the European guideline relate to a long-term storage of so-called speech accompanying data such as time, duration, participating call numbers or identifications.

If an expanded guideline should also apply to the contents of stored telecommunications connections, the present subject matter of the invention in the embodiment described here covers these expanded requirements.

This also applies for the application that in principle all telecommunications connections must be recorded by the network operators, if this should become a legal guideline someday.

### Access

The telecommunications subscribers or Third Parties can access the connection-accompanying data in different ways and with differing authorization after completion of the telecommunications connection.

For this purpose diverse possibilities are available depending on the embodiment and type of telecommunications connection, said possibilities being able to be realized in parallel or individually:

Access of the Telecommunications Subscribers

Only those whose personal data are contained in a data record with connection-accompanying data have access to the data record. The access can for example take place via web interface. If a data record contains personal data about several persons, all of these persons must give their consent prior to the access.

Hence the calling subscriber can only access the data record with the call numbers of the caller and of the person being called if the person being called has also given consent to the access. If the call number of the person being called is displayed in the data record anonymized or shortened, this consent of the person being called can be omitted.

Access By Employees Of The Network Operator With Explicit Release By The Telecommunications Subscribers

An access by employees of the network operator (for example by employees in customer service who are processing inquiries about invoices) to the connection-accompanying data about the telecommunications connections of this telecommunications subscriber can take place after express release by the telecommunications subscriber. The telecommunications subscriber can also restrict the release as needed (for example restricting it to a specific time period, to conversations with a specific destination call number).

Access By Employees Of The Network Operator Without Explicit Release By The Telecommunications Subscribers

An access by employees of the network operator (for example by employees who suspect technical misuse to the disadvantage of Third Parties) to the connection-accompanying data about the telecommunications connections can also take place without express release by the telecommunications subscriber in question. Preferably a double verification principle should be realized here so that an access of a single employee cannot take place without consent or collaboration of an additional employee or of a neutral Third Party. The neutral Third Party can for example be an employee of a government agency authorized for this purpose.

Access By Third Parties Without Release By The Network Operator Or The Subscriber. In the case of appropriate authorization for example by court order, Third Parties, such as for example government agencies, can access connection-accompanying data of telecommunications connections of individual subscribers.

In order to realize the possibilities for access described here, the connection-accompanying data should be stored with appropriate protection. Preferably the data should be duplicated and encrypted in such a way that a decryption is only possible in cooperation of the authorized Parties and those Parties that must necessarily be involved.

The telecommunications subscribers or Third Parties can access the “recording” of the telecommunications connection in different ways and with differing authorization after completion of the telecommunications connection.

For this purpose diverse possibilities are available depending on the embodiment and type of telecommunications connection, said possibilities being able to be realized in parallel or individually:

Access via Web Interface

This means that the recording of the telecommunications connection can be stored by download to one's own computer.

As an alternative the recording especially of a telephone conversation can be intercepted on one's own computer by means of audio streaming without a direct download option existing in this connection. Audio streaming can also be used for text-based telecommunication such as SMS or e-mail if said text-based telecommunication is automatically converted to audio signals.

Access By Means Of Electronic Communication, For Example By E-Mail.

This means that a data file of the recorded conversation is sent in a suitable format by attachment of an e-mail to an e-mail address of the subscriber to be saved in advance in the system. Other forms of an electronic communication, such as for example by MMS (Multimedia Messaging Service), are also possible.

Access By Audio Message To One's Own End Device, If For Example Via A Call To Subscriber A Or B The Recorded Conversation Is Played Back, So That The Conversation Can Be Listened To Once Again By Subscriber A Or B.

For this purpose the switching system, depending on the embodiment for example by SMS makes an, if necessary cost-free call number and information on the referencibility of the respective conversation available to the subscribers. If the subscriber selects this call number, he receives the opportunity to listen to the recording.

This aforesaid access type has already been disclosed with the invention DE 101 61 660 A1 harking back to the same applicant, wherein said invention discloses a method for synchronous distribution of random audio information, such as language, sounds and/or noises preferably time-shifted to several recipients in a message network, wherein the information as digital/analog signals to predetermined recipients directly, or after notification about the presence of information for the appropriate recipient is sent or can be called by said recipient.

To avoid misuse appropriate security mechanisms are to be implemented in order to safeguard access to the contents of the recorded telecommunications connections by unauthorized persons pursuant to the applicable guidelines.

Thus the access to the corresponding data file can preferably take place only by a joint and equal access by the caller and the person being called.

For this purpose the files are encrypted on the system side, wherein a decryption of the files is possible exclusively by a joint encryption of both subscribers.

This means that both parties have only a part of the necessary cryptographic key necessary for decryption.

As an alternative the data file is double encrypted, wherein the caller has the first necessary key for encryption and the person being called has the other one, as a result of which here to the decryption can only take place jointly.

In principle in this connection the application of asymmetrical crypto methods, such as for example the “PGP” method (Pretty Good Privacy Method) is to be recommended.

A secure embodiment of an access via a Web interface will be briefly described in the following.

Two subscribers A and B each have access to the system upon which the encrypted telecommunications connection files are stored, each said file being protected via a password or other protection methods known from the state of the art.

A correct input of the password permits access to the conversation data files which however are still encrypted with the cryptographic keys of both subscribers participating in the conversation.

Subscriber A can release the conversation data files for decryption with his decryption key by performing a selection of said conversation data files.

However, access to the corresponding data files of the recorded conversations for conversation partner A is only possible when conversation partner B has also released said data files and vice versa.

This means that only through a joint release of both participating conversation partner A and B are the released files available for downloading or audio streaming to the participating conversation partner A and B.

So that also Third Parties who are authorized for this purpose, achieve access to a stored file of a telephone conversation or of a telecommunications connection e.g. between subscribers A and B, further copies of the original or digitized and recoded data files can be created on the system side, which are encrypted with a cryptographic key assigned to the respective Third Party.

A Third Party receives access correspondingly via an access assigned to him.

The subject matter of the present invention does not just result from the subject matter of the individual patent claims, but rather also from the combination of the individual patent claims with one another.

All information and features disclosed in the documents, including the abstract, in particular the developments of the subject matter of the invention disclosed in the description, are claimed as essential to the invention, to the extent to which they are novel individually or in combination vis-a-vis the state of the art.

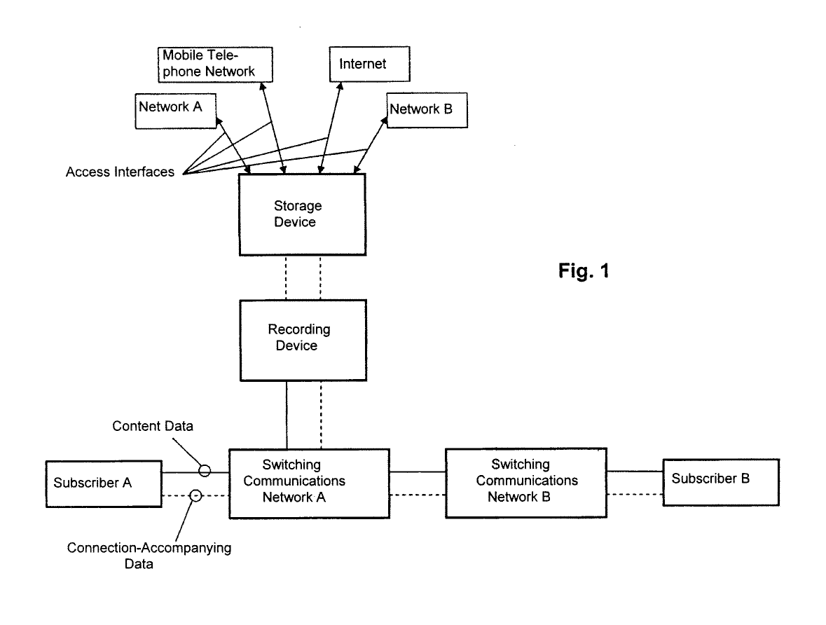

FIG. 1 schematically shows one possible realization of the method on a communications network. One or more communications networks and subscribers can be involved in the process flow. A recording device and a storage device for the data files can be present in only one or in all involved communications networks. An access to the data files stored in the storage device can take place via corresponding access interfaces. The access can take place via one of the involved communications networks, the Internet, a mobile telephony network or other public or specially installed data connections.

We claim:

1. A method for the access management of connection-accompanying data of telecommunications connections, wherein within the scope of a telecommunications connection the associated connection-accompanying data are generated and stored in a system, characterized in that both the storage as well as also access to the data take place according to freely selectable specifications of the respective telecommunications subscriber and/or the respective network operator involved, wherein the data for a telecommunications connection to be stored are in a data file in the used telecommunications network protected from general access.

2. The method according to claim 1, characterized in that the recording or storing of data files of a telecommunications connection is carried out on the mobile telephony network, fixed network or on the Internet by at least one of the network operators involved.

3. The method according to any one of preceding claim 1 or 2, characterized in that the network operator records and stores all telecommunications connections as a basic principle.

4. The method according to any one of the preceding claims 1 through 3, characterized in that the stored data files of a telecommunications connection are protected from unauthorized access.

5. The method according to any one of the preceding claims 1 through 4, characterized in that the prior to the storage of the telecommunications data files a recoding of the data takes place.

6. The method according to any one of preceding claims 1 through 5, characterized in that the storage of the data files of the telecommunications connections takes place in a cryptographically secured manner.

7. The method according to any one of preceding claims 1 through 6, characterized in that the storage of the data files of a telecommunications connection is not carried out until prior logon and consent of all the subscribers of a telecommunications connection, wherein the logon information of the subscribers of the telecommunications connection is exchanged between two different network operators, such as for example fixed network and mobile telephony network of different network providers prior to the storage.

8. The method according to any one of preceding claims 1 through 7, characterized in that the storage of the data files of a telecommunications connection is not carried out until the logon and consent of the subscribers of a telecommunications connection, wherein the information about the consent of the subscribers of the telecommunications network connection is centrally stored in a database and said information is queried and evaluated during the establishment of the connection of the respective telecommunications connection.

9. The method according to any one of preceding claims 1 through 8, characterized in that the storage of the data files of a telecommunications connection is not carried out until the consent of the subscribers of a telecommunications connection, wherein the consent of both conversation partners is carried out at the beginning of the respective telecommunications connection by means of generated questions and explicit consent of the subscribers of the telecommunications connection.

10. The method according to any one of preceding claims 1 through 9, characterized in that the data of network operators are recorded according to the specifications of third parties, for example government agencies, which arrange recording of all telecommunications connections of subscribers to be determined for a specific time period.

11. The method according to any one of preceding claims 1 through 10, characterized in that an access of authorized persons to the stored data files of the telecommunications connections can be carried out by means of Web interface for downloading or by means of electronic communication.

12. The method according to any one of preceding claims 1 through 11, characterized in that an access to the data files requires the release of the secured stored data files by all subscribers of the telecommunications network or by those subscribers of the telecommunications network whose personal data such as for example their own call number are contained in the data files.

13. The method according to any one of preceding claims 1 through 12, characterized in that the consent of a subscriber can be omitted when the call number of a subscriber is displayed in the data record anonymized or shortened.

14. The method according to any one of preceding claims 1 through 13, characterized in that an access to the decrypted recording of a telecommunications connection by third parties, for example authorized government agencies, does not require the release and decryption of the encrypted stored data files by all subscribers of the telecommunications network.

15. The method according to any one of preceding claims 1 through 14, characterized in that an access to the data files by the network operator can be performed with explicit release by the telecommunications subscriber.

16. The method according to claims 15, characterized in that the telecommunications subscriber can grant the network operator a restricted release for access to the data files, for example restricted to a specific time period, to conversations with a specific destination call number.

17. The method according to any one of preceding claims 1 through 16, characterized in that an access to the data files by the network operator can be performed without explicit release by the telecommunications subscriber, wherein here preferably a double verification principle is realized, so that an access of a single employee of the network operator cannot take place without consent or collaboration of an additional employee or of a neutral Third Party, wherein the neutral Third Party can for example be an employee of a government agency authorized for this purpose.

18. The method according to any one of preceding claims 1 through 14, characterized in that an access to the data files by Third Parties can be performed without release by the network operator or the subscriber.

19. The method according to claim 18, characterized in that Third Parties, for example government agencies, in the case of appropriate authorization for example by court order can access the data files or connection-accompanying data of the telecommunications connections of individual subscribers.

20. The method according to any one of preceding claims 1 through 19, characterized in that along with the connection-accompanying data also the contents of the assigned telecommunications connections are recorded.

21. The method according to any one of preceding claims 1 through 20, characterized in that a device generates the connection-accompanying data of a switching system participating in the connection in one of the involved networks and the generated connection-accompanying data are forwarded to a system which stores said data in a suitable data format and for example cryptographically secures them.
